(19) United States
(12) Patent Application Publication
(10) Pub. No.: US 2025/0014006 A1
(43) Pub. Date: Jan. 9, 2025

(54) INTERACTIVE BARTENDER

(71) Applicant: Minga Box Ltd., Kfar Saba (IL)

(72) Inventors: Gal Kalkshtein, Kfar Neter (IL); Lital Kalkshtein, Kfar Neter (IL); Elad Kobi, Tel Aviv (IL)

(73) Assignee: Minga Box Ltd., Kfar Saba (IL)

(21) Appl. No.: 18/891,645

(22) Filed: Sep. 20, 2024

Related U.S. Application Data
(63) Continuation of application No. 18/109,669, filed on Feb. 14, 2023.

(51) Int. Cl. G06Q 20/18; G06F 16/903; G06Q 20/40; G06T 11/00; G06T 13/40; G10L 15/22

(52) U.S. Cl. CPC G06Q 20/18; G06F 16/90344; G06Q 20/4014; G06T 11/001; G06T 13/40; G10L 15/22; G10L 2015/223

(57) ABSTRACT

Disclosed herein are system, method, and device embodiments for, interactive bartender that engages with customers in natural languages and dispenses a selected drink. The behavior, dialogue, and personality of the interactive bartender, branding, beverage menu, and other aspects of the experience are fully customizable. The interactive bartender may also access a variety of third-party application programming interfaces to further customize the experience, including accessing an identification verification service to verify the authenticity of a government identification and a payment service to receive payment for selected drinks.

### CROSS-REFERENCE TO RELATED APPLICATIONS

This application is a continuation of U.S. patent application Ser. No. 18/109,669 by Kalkshtein, et al., titled “Interactive Bartender,” filed Feb. 14, 2023, which is incorporated by reference herein in its entirety.

### BACKGROUND

People get thirsty and love to quench their thirst with a tasty beverage. Thus, many businesses sell drinks to customers. These businesses may be restaurants, bars, casinos, cruise ships, sports stadiums, convention centers, markets, hotels, museums, and others.

A beverage is a liquid consumed by a person. Some beverages are iced or hot. Some beverages include alcohol or caffeine but others do not. Some beverages incorporate solid ingredients such as salts, fruits such as cherries, sliced lemons, limes, and oranges, rosemary and other herbs, and other garnishes. Some beverages may even come with a toothpick made to look like a beach umbrella, incorporate smoke or fire, or include other novelties.

Conventionally, a customer that wants a beverage must wait in line, approach a bartender, provide an order, wait for the beverage to be made, pay for the beverage, and then, finally, at long last, receive the beverage. In some situations, this interaction is desirable. Engaging with the bartender may be enjoyable. Indeed, the witty repartee between customer and bartender may be an important part of the bar-going experience.

But in other situations, a streamlined, automated experience may be more appropriate—e.g., in situations where a large number of people congregate and throughput is of paramount importance. In these situations, quickly receiving a drink may outweigh the desirability of interacting with a human bartender. People do not like to wait in line, after all.

A bartender kiosk may improve throughput (i.e., the number of drinks that can be made and served per minute) over human operators. However, even when interacting with a bartender kiosk, customers may still desire natural, conversational interactions that approximate conventional human-bartender interactions.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 illustrates an interactive bartender kiosk, according to some embodiments.

FIGS. 2A-2C are example screen displays of an interactive bartender, according to some embodiments.

FIG. 3 is a block diagram of an architecture that supports an interactive bartender kiosk, according to some embodiments.

FIG. 4 illustrates microcontroller used in an interactive bartender kiosk to dispense beverages, according to some embodiments.

FIGS. 5A-5I are example screen displays of a web portal for configuring interactive bartenders, according to some embodiments.

FIG. 6 illustrates a method for processing spoken input received from a customer and communicating a response to the customer using an interactive bartender, according to some embodiments.

FIG. 7 illustrates a method for dispensing a selected beverage to a customer, according to some embodiments.

FIG. 8 illustrates a computer system, according to exemplary embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof for providing a fully customizable, interactive bartending experience. An interactive bartender kiosk combines artificial intelligence, computer graphics, web technologies, and mechanical elements to deliver an interactive bartender that engages with customers, offers a menu of beverages, and dispenses selected beverages. The experience is fully customizable—from the menu of beverages and their compositions to the appearance, behavior, and dialog of the interactive bartender and branding of the overall experience.

Conventionally, businesses employ bartenders, waitstaff, cashiers, and other individuals to receive orders, prepare beverages, accept payments, and serve customers. Bartenders are often highly conversant and blessed with the gift of gab, and the conversation shared between the bartender and the customer may be an integral part of the bar-going experience.

However, for a variety of reasons, businesses may employ automated approaches to serving beverages. In situations where a business must serve a large amount beverages in a short amount of time, such an automated approach may be advantageous. In these situations, higher throughput may be prioritized over a human touch—e.g., on a cruise ship, at a sporting event, in a convention center, etc. In some situations, it may not be cost effective to employ a human being.

However, legacy approaches to serving beverages using automation fail to interact naturally with customers. The disclosed interactive bartender kiosk improves upon these legacy tools by providing a next-level automated solution that achieves high throughput but retains natural, conversational interactions between bartender and customer. An interactive bartender displayed on a screen in the bartender kiosk may interact with customers using natural language. In the disclosure below and accompanying figures, this interactive bartender may receive spoken words from the customer as input, determine an appropriate response to the spoken input, and communicate the response back to the customer in natural language.

During these interactions, the interactive bartender may provide a menu of beverages to the customer, receive an order from the customer, and dispense the selected beverage. To dispense beverages, the interactive bartender kiosk may house a number of containers storing ingredients. The menu of beverages may be preconfigured by an administrator, and an administrator may specify a quantity of each ingredient for each beverage. The administrator may also configure appropriate details about each beverage—e.g., name, description, associated image, etc. When the customer selects a beverage, the interactive bartender kiosk may engage a microcontroller to dispense the selected beverage in the pre-configured proportions into a receptacle. The customer may then enjoy the beverage.

But programming an interactive bartender to communicate with a customer in a manner that actually feels human and engaging presents a technical problem. Legacy solutions are insufficient in this regard and may resort to offering a touchscreen menu with no life-like human interactions.

Accordingly, a need exists to furnish a conversant, engaging, humorous, and adaptive interactive bartender. In one embodiment, the interactive bartender may leverage a configurable keywords list, and each record in the keywords list may include a match string, a text response, and priority. The interactive bartender kiosk may receive spoken words as input using a microphone, translate the spoken input to a readable string, and then determine an appropriate response for the interactive bartender by referencing the configurable keywords list. For instance, the interactive bartender may determine records in the configurable keywords list where the records' match strings include words in the readable string. The interactive bartender may then select a record from this subset of records having a highest priority, pseudo-randomly, or using another appropriate approach. The interactive bartender may then create an audio file of the text response and communicate the appropriate response back to the customer in natural language via the audio file, perhaps accompanied by a fitting gesture or animation (also configured).

Moreover, legacy systems fail to sufficiently customize an interactive bartender. Different businesses may need to present very different branding for an interactive bartending experience. Even the personality of the interactive bartender may need to differ based on the business and location. For example, a hotel may want an interactive bartender to behave in one way, while a sports stadium may want an interactive bartender to behave in another. Certain interactions and behaviors that are appropriate for a bartender in a classy hotel may differ from the behaviors expected of a bartender in a dive bar.

The features offered by particular businesses may differ as well. For example, a hotel may want to provide concierge features, e.g., provide additional information about the hotel, access information on a room key, and generally respond to guests' needs. An interactive bartender in a sports stadium may provide information about the sports team, give score updates, provide statistics, etc. An interactive bartender in a casino may receive bets on sporting events or offer table games.

Accordingly, a need exists to provide an interactive bartender kiosk that is fully customizable. By allowing an organization to configure the keywords list used by the interactive bartender, the behavior, dialogue, and personality of the interactive bartender may be tailored to organizations' unique requirements. An organization may associate different animations with each response in the keywords list to further customize the interactive bartender. The branding of the experience may be uniquely tailored by configuring a background, texture, and other visual elements of the experience. For example, an interactive bartender at a sports stadium may wear the baseball team's hat and uniform and have stadium seating in the background while an interactive bartender at a hotel may wear dress clothes and have a dimly lit bar-back of candles and bottles of alcohol in the background.

A business may also configure the menu of the beverages offered by the interactive bartender. For example, a beach bar may configure a menu of fruity cocktails that one customarily drinks at the beach while a classy hotel may configure a variety of whiskey and gin cocktails. Moreover, an administrator may configure exact proportions of the ingredients in each drink in accordance with their own recipes and preferences. Additionally, the organization may configure threshold values (i.e., a warning value and a stop value) for each ingredient that aid in maintaining the interactive bartender by alerting staff when ingredients near exhaustion. In such an instance, the ingredients may need to be refilled or the interactive bartender reconfigured.

Another technical problem exists in mixing certain drinks. Some drinks have particular preparation requirements that a human bartender may be able to adapt to—e.g., some individuals prefer drinks to be shaken and not stirred. However, actually mixing a drink presents a technical challenge in an interactive bartender kiosk that lacks a robotic arm.

Accordingly, a need exists to mix beverages ordered via the interactive bartender. In one embodiment, mixing may be achieved by staggering the pouring of the ingredients. For example, a simple gin and tonic consisting of 1 part gin and 1 part tonic may be mixed by dividing the parts into smaller parts and staggering the pouring. That is, pouring a portion of gin, then a portion of tonic, then a portion of gin, then a portion of tonic, etc. resulting in a pre-mixed drink for the customer.

Another technical problem exists in verifying that a customer is of a legal age. This requirement may vary across jurisdictions based on applicable rules and regulations. But in general, a customer must prove that their age to purchase beverages that contain alcohol. Legacy systems provide insufficient solutions to verify that a potential customer is of legal age.

Accordingly, a need exists to scan a government identification at the interactive bartender kiosk and employ a verification service to verify the authenticity of the identification. The interactive bartender kiosk may compare the picture on the identification with a scan or examination of the customer's face. In one embodiment, the interactive bartender kiosk may receive only a hashed identifier or string representing the user without storing or transmitting identifying information for data security. In future interactions, only the hashed identifier needs to be referenced by the interactive bartender.

Another technical problem exists in integrating third-party systems and application programming interfaces (“APIs”) into the interactive bartender experience. An interactive bartender is uniquely positioned to improve the human-bartender experience by programmatically accessing a trove of additional information and functionality in the form of third-party APIs. For example, an interactive bartender in a hotel may leverage third-party systems offering hotel-specific concierge functionality.

Accordingly, a need exists to engage third-party systems via an interactive bartender kiosk and to allow the third-party integration to be fully customizable alongside the other, above-described customizable aspects of an interactive bartender.

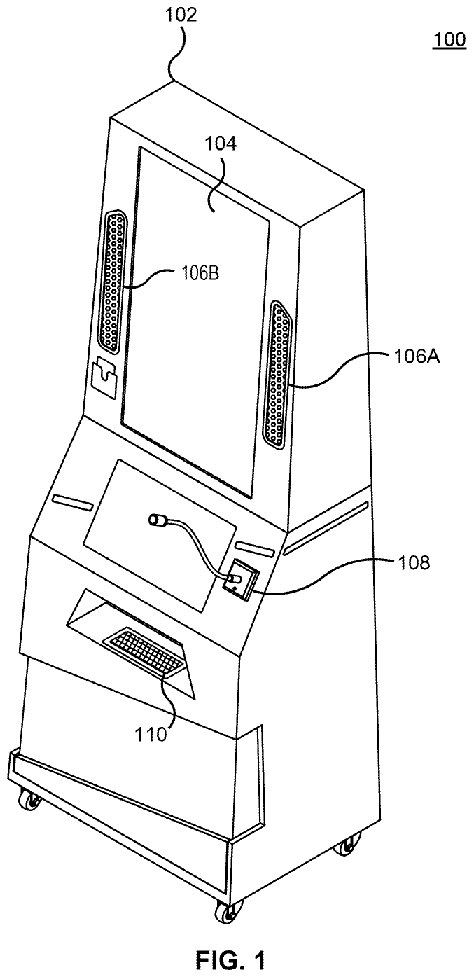

FIG. 1 illustrates interactive bartender kiosk 100, according to some embodiments. As illustrated in FIG. 1, interactive bartender kiosk 100 may include enclosure 102, screen 104, speakers 106, microphone 108, and bay 110. Interactive bartender kiosk 100 may provide a high-throughput drink-making solution that naturally converses with customers using an interactive bartender displayed on screen 104. The interactive bartender kiosk may receive spoken words from the customer and communicate a response back via the interactive bartender. The particular physical aspects of interactive bartender kiosk 100 are merely illustrative, and one skilled in the art will appreciate that different forms, structures, and design methodologies may be employed to provide interactive bartender kiosk 100 that delivers the features described below.

Enclosure 102 may be a container, structure, or other construction made of wood, plastic, metal, or other suitable material. Enclosure 102 may include computers, circuitry, electrical and mechanical elements, tubing and pumps, etc. Enclosure 102 may include electrical components to receive power and wiring to provide the power to other components within enclosure 102. Enclosure 102 may include a plurality of containers that may be filled with ingredients—e.g., alcohol, juices, mixes, etc. In one embodiment, enclosure 102 may include twelve such containers, but this is merely exemplary, and other numbers of containers may be employed within the scope of this disclosure. Enclosure 102 may also include tubing and pumps and mechanisms to dispense beverages. Enclosure 102 may include refrigeration components for cooling or heating elements for heating. Enclosure 102 may also include a network or data connection via a secure wireless connection via a Local-Area Network (LAN), a Wide-Area Network (WAN), or the Internet. Such a network connection allows the various configurable aspects of the interactive bartender described below to be remotely configured.

Screen 104 may be a component that displays computer graphics in a format appropriate for viewing by customers. The content displayed may include the interactive bartender described below. Screen 104 may be a monitor, screen display, television, virtual reality headset, or other such suitable output device capable of displaying computer graphics. Screen 104 may also include a touchscreen and receives touch inputs from its users.

Speakers 106 may be an electronic transducer that converts an electric audio signal into an audible sounds. Speakers 106 may play audio representations of text responses for a potential customer and other sounds.

Microphone 108 may be a transducer or other sensor that receives spoken input produced by a customer and converts the sound wave produced by the customer into an electric signal. Interactive bartender kiosk 100 may use the electronic signal to determine the words spoken by the customer. The interactive bartender may convert the words spoken into microphone 108 into a readable string, determine an appropriate response, and play the response back to the customer using speakers 106, as described in further detail below.

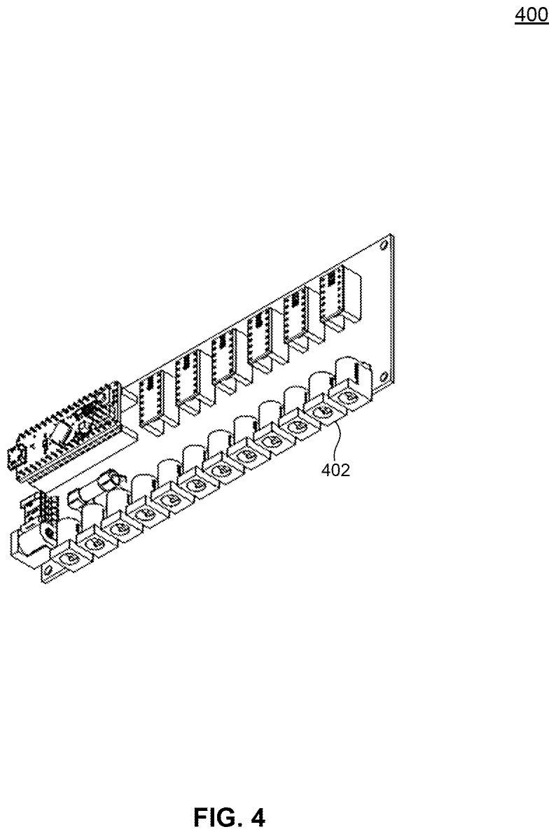

Bay 110 may be a compartment of interactive bartender kiosk 100 that dispenses a selected beverage into a receptacle for consumption by a customer. Tubes for each of the ingredients in the plurality of containers may route to bay 110. In an example where kiosk 100 supports 12 ingredients, 12 tubes may lead to bay 110. Each of the 12 tubes may be routed through a pump (not shown). Each of the pumps may be controlled by a microcontroller, as described below with respect to FIG. 4. In one embodiment, a user may place a receptacle (glass, cup, mug, etc.) into bay 110. Interactive bartender kiosk 100 may dispense a selected beverage by engaging a microcontroller to pump stored ingredients in the pre-configured quantities into the receptacle. In another embodiment, interactive bartender kiosk 100 may supply the receptacle, place the receptacle within bay 110, dispense the beverage into the receptacle, and the customer may then retrieve the beverage-filled receptacle. Bay 110 may include suitable drainage facilities or additional components for containing spilled liquids. In one embodiment, bay 110 may be removable for case of cleaning and maintenance.

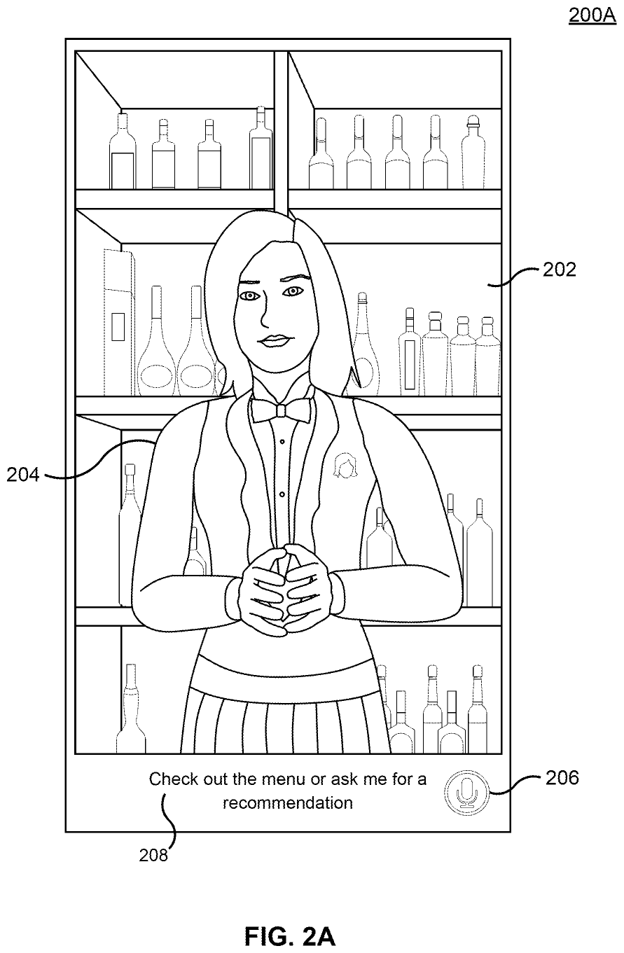

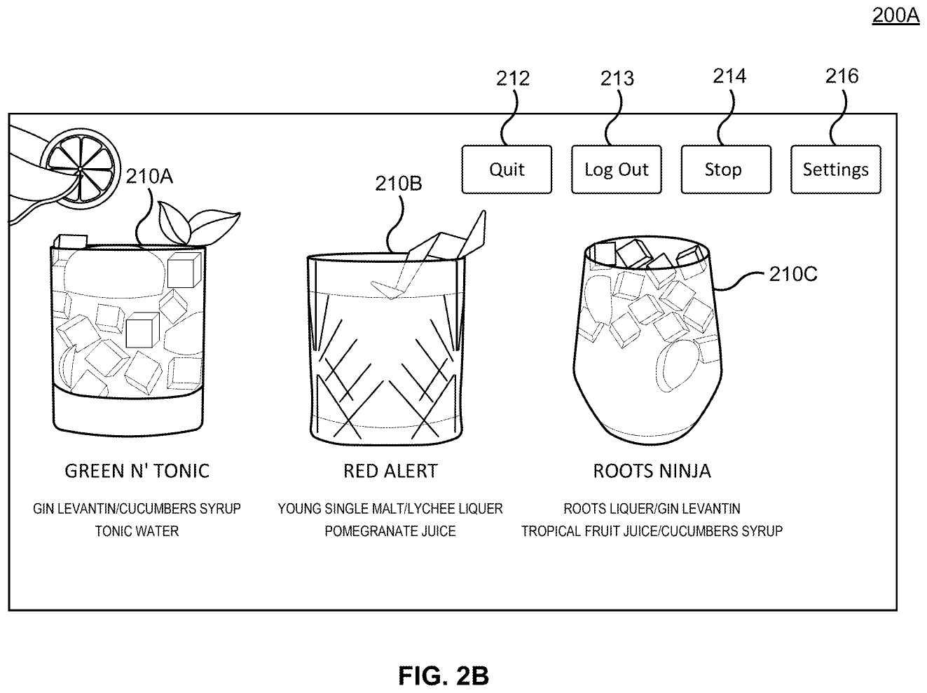

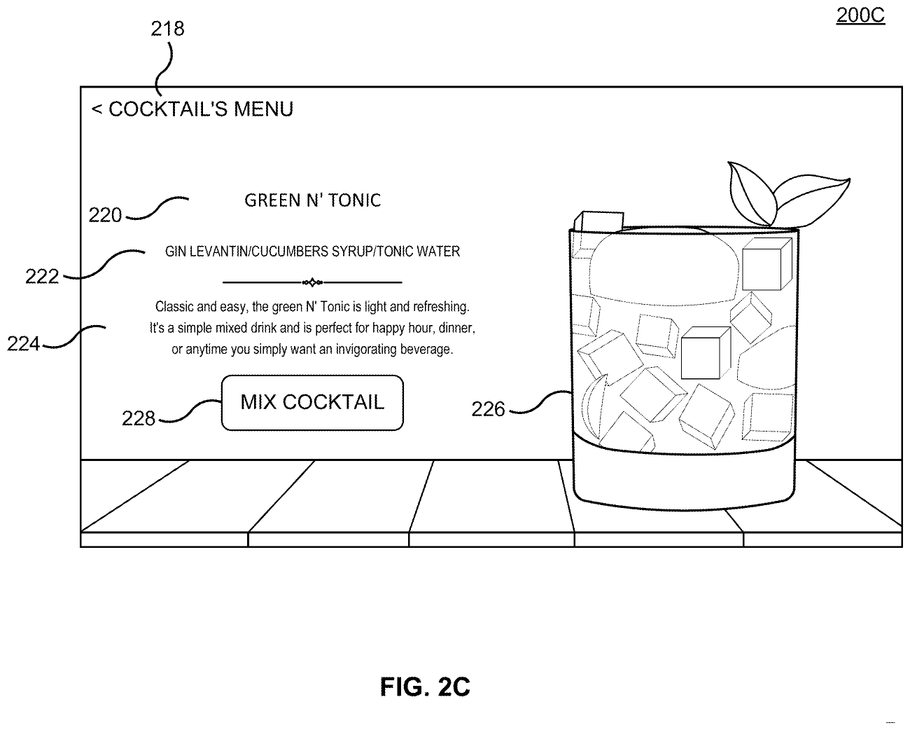

FIG. 2A is an example screen display 200A of an interactive bartender, according to some embodiments. The screen display provided in FIG. 2A is merely exemplary, and one skilled in the relevant art(s) will appreciate that many approaches may be taken to provide a suitable screen display 200A and a configurable interactive bartender in accordance with this disclosure. Screen display 200A may include background 202, interactive bartender 204, microphone icon 206, and response text 208.

Background 202 may be a digital image that provides an environment in which interactive bartender 204 operates. Background 202 may be customized via a web portal, e.g., an administrator may upload an appropriate image to the web portal to serve as a background for a particular configured interactive bartender. Various file formats and image sizes/resolution may be supported including Graphics Interchange Format (GIF), Joint Photographic Experts Group (JPEG), Portable Network Graphics (PNG), Tag Image File Format (TIFF), etc., as will be understood by those skilled in the arts. Selectable templates may also be provided for easy selection via the web portal that can serve as background 202. A default background may be applied in the absence of a configured background. In the exemplary embodiment provided in screen display 200A, a typical bar setup is illustrated. In other embodiments, different backgrounds may be appropriate, e.g., at a sports stadium the team colors may be displayed, at a casino a card table may display, etc.

Interactive bartender 204 may be an avatar, e.g., a two- or three-dimensional representation of an engaging bartender. Interactive bartender 204 may be readily configurable via a web application described below. The avatar of interactive bartender 204 may be uploaded or selected from pre-existing templates. In an embodiment, the clothes, hair color, and other physical attributes of interactive bartender 204 may be customized individually. A default image may be provided that serves as interactive bartender 204. Interactive bartender 204 may be configured to perform an animation when responses are played to the customer. Interactive bartender 204 may move her mouth when communicating with customers in a manner that approximates human speech and lip movements.

Microphone icon 206 may alert a customer that microphone 108 is on and that the interactive bartender may receive spoken text as input. Microphone icon 206 may change color when microphone 108 is turned on or off. This ensures that the user is not providing input to the interactive bartender and expecting a response when the interactive bartender is not prepared to receive the input.

Response text 208 may display a written form of the text responses provided to customers. This provides a redundant version of spoken responses in the case that the room is loud, the listener is hearing impaired, or to generally reinforce communication.

FIG. 2B is an example screen display 200B of a menu of beverages provided by an interactive bartender, according to some embodiments. The screen display provided in FIG. 2B is merely exemplary, and one skilled in the relevant art(s) will appreciate that many approaches may be taken to provide a suitable screen display 200B in accordance with this disclosure. Screen display 200B may be displayed to respond to an appropriate request from a customer to view a menu of the available beverages. Screen display 200B may include beverages 210, quit button 212, stop button 214, and settings button 216.

Beverages 210 including beverage 210A, beverage 210B, and beverage 210C may present a menu of drinks configured by an administrator. Beverages 210 may include the drinks that the interactive bartender serves on screen 104 in format suitable for viewing by the customer. Beverages 210 may be configured to have a name, description, and associated image. Beverages may be scrollable from right to left, display all of the beverages on a single page, or use other suitable interface design approach to convey the available beverages. In example screen display 200B, beverage 210A is a “Green N′ Tonic,” beverage 210B is a “Red Alert,” and beverage 210C is a “Roots Ninja.” Beverages 210 may be displayed next to or in addition to interactive bartender 204, e.g., below, above, or alongside the interactive bartender. In another embodiment, beverages 210 may temporarily replace interactive bartender 204 on screen 104. In another embodiment, beverages 210 may be communicated in spoken conversation to the customer, and the information in screen display 200B thus communicated orally.

Quit button 212, log out button 213, stop button 214, and settings button 216 are examples of navigation buttons that may be used by the customer and/or administrators to maneuver between screens. Quit button 212 may allow a user to quit the menu of beverages and return to a prior menu. Log out button 213 and/or stop button 214 may stop the interactive bartender experience and/or return the user to a top-level menu page. Settings button 216 may allow an administrator to configure the interactive bartender and may only be available to administrators that are testing interactive bartender 204.

FIG. 2C is example screen display 200C of a details page of a beverage on a pre-configured menu, according to some embodiments. In an embodiment, screen display 200C may be accessed from the menu of beverages discussed above in screen display 200B. For example, a customer may use a touchscreen or orally request the details for a particular beverage in the menu of beverages. The screen display provided in FIG. 2C is merely exemplary, and one skilled in the relevant art(s) will appreciate that many approaches may be taken to provide a suitable screen display 200C in accordance with this disclosure.

Screen display 200C may include return button 218, beverage title 220, ingredients 222, description 224, image 226, and mix cocktail button 228. Return button 218 may return the customer to the menu of beverages or provide other navigational options. Beverage title 220 may be a configured name for the beverage. In this example, the customer has selected the “Green N′ Tonic” drink, either in spoken language or using the touchscreen and accessed the details page for this drink.

Ingredients 222 may list the ingredients that make up the beverage, in this case “Gin Levantin,” “Cucumbers Syrup,” and “Tonic Water.” Description 224 may be a configured description of the beverage, in this case “Classic and easy, the Green N′ Tonic is light and refreshing. It's a simple mixed drink and is perfect for happy hour, dinner, or anytime you simply want an invigorating beverage.” Image 226 may an image configured to be associated with the beverage.

Mix cocktail button 228 may cause interactive bartender kiosk 100 to dispense a selected beverage. In another approach, the customer may just orally ask the interactive bartender to prepare the beverage, e.g., the customer may say out loud “Make me a Green N′ Tonic” and interactive bartender 204 may recognize the request and pour the appropriate ingredients in the configured proportions into a receptacle in bay 110.

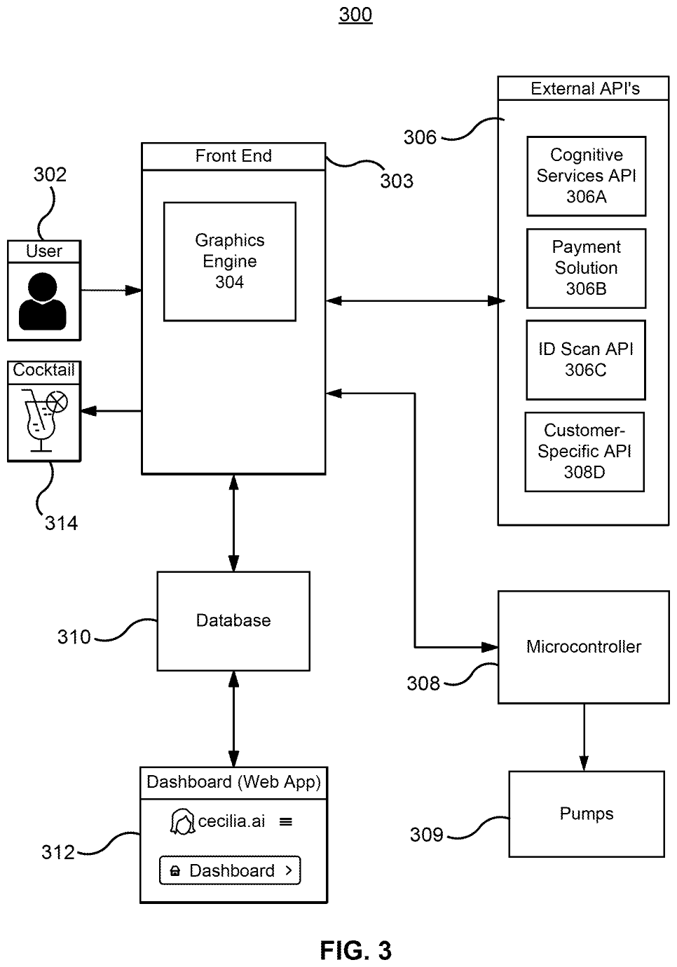

FIG. 3 is a block diagram of architecture 300 that supports interactive bartender kiosk 100, according to some embodiments. As illustrated in FIG. 3, environment 300 may include customer 302, graphics engine 304, external APIs 306, microcontroller 308, database 310, dashboard 312, and dispensed beverage 314.

Customer 302 may an individual accessing interactive bartender kiosk 100 to interact with interactive bartender 204 and/or order a beverage. Customer 302 may be physically present in front of or near interactive bartender kiosk 100 to be able to provide spoken input and hear or read text responses from the interactive bartender. For instance, customer 302 may a patron of a hotel, a sports fan attending a sporting event, a diner at a restaurant, a gambler at a casino, etc.

As discussed above with reference to FIG. 1, interactive bartender kiosk 100 may incorporate one or more computers or electronic devices that use software to provide the features of interactive bartender 204. This device(s) are reflected in FIG. 3 as front end 303. Front end 303 may be a suitable application server, web server, personal computer, or other computing device coupled with the input/output components of interactive bartender kiosk 100. Front-end 303 may perform relevant calculations on premise but may also interact with external devices, for instance, a hosted environment or the cloud. The features of front end 303 may be implemented using a suitable high-level programming language, e.g., C #, C/C++, Java, Perl, etc.

Front end 303 may leverage graphics engine 304, which may be used to generate the three-dimensional and two-dimensional graphics that bring interactive bartender 204 to life. In one embodiment, graphics engine 304 may be a UNITY game engine that serves as a real-time 3D platform. Graphics engine 304 may have various software components installed on computers running in interactive bartender kiosk 100 that achieve these features.

External APIs 306 may be accessed by front end 303 to perform various functions. External APIs 306 may be REST APIs accessible through HTTP and other suitable protocols. External APIs 306 may include cognitive services API 306A, payment solution API 306B, IDScan API 306C, and customer-specific API 306D.

Cognitive services API 306A may be a cloud-based artificial intelligence API that front end 303 may access as an endpoint. As discussed below, front end 303 may transmit a representation of the spoken input as a parameter to cognitive services API 306A and receive in return a readable string. Cognitive services API 306A may provide a specific endpoint for performing this feature. Similarly, front end 303 may determine an appropriate text response, transmit the text response to cognitive services API 306A, and receive an audio file representing the text response in speech from cognitive services API 306A. Again, cognitive services API 306A may provide appropriate endpoints/functions for achieving this feature. In another embodiment, front end 303 may perform the services provided by cognitive API 306A locally using appropriate software modules or functions.

Payment solution API 306B may offer services related to accepting and processing credit card payments and other cashless forms of payment. Payment solution API 306B may accept barcode scans, QR codes, APPLE Pay integration, and other suitable payment mechanisms. Front end 303 may receive appropriate information about payment for a beverage from customer 302, formulate an appropriate API call based on the received information, transmit the information to payment solution API 306B, receive confirmation of received payment, provide confirmation of the payment to customer 302, and perform other suitable functions related to payment processing.

IDScan API 306C may provide identification verification technology. IDScan API 306C may read a government ID within a jurisdiction in real-time, determine the authenticity of the government ID, and provide appropriate fields (e.g., an age) in response to an appropriate formatted API request. Front end 303 may verify that an individual is of an appropriate age to purchase an alcohol beverage in the relevant jurisdiction using IDScan API 306C. In an embodiment, front end 303 may verify that the image on the provided identification matches a facial scan of the individual in front of interactive bartender kiosk 100. In another embodiment, IDScan API 306C may return a hash string representing the verified customer that can be used to track the customer for future purchases. This approach anonymizes and secures the identification-validation process because identifying user information does not need to be stored or transmitted. In another embodiment, front end 303 may perform the services provided by IDScan API 306C locally.

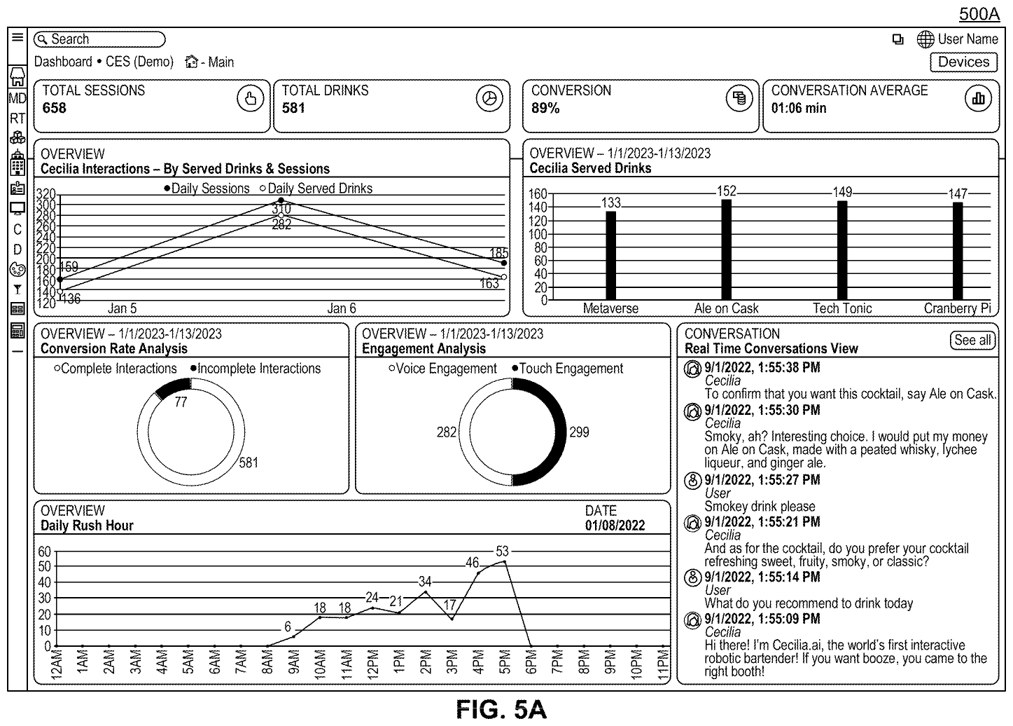

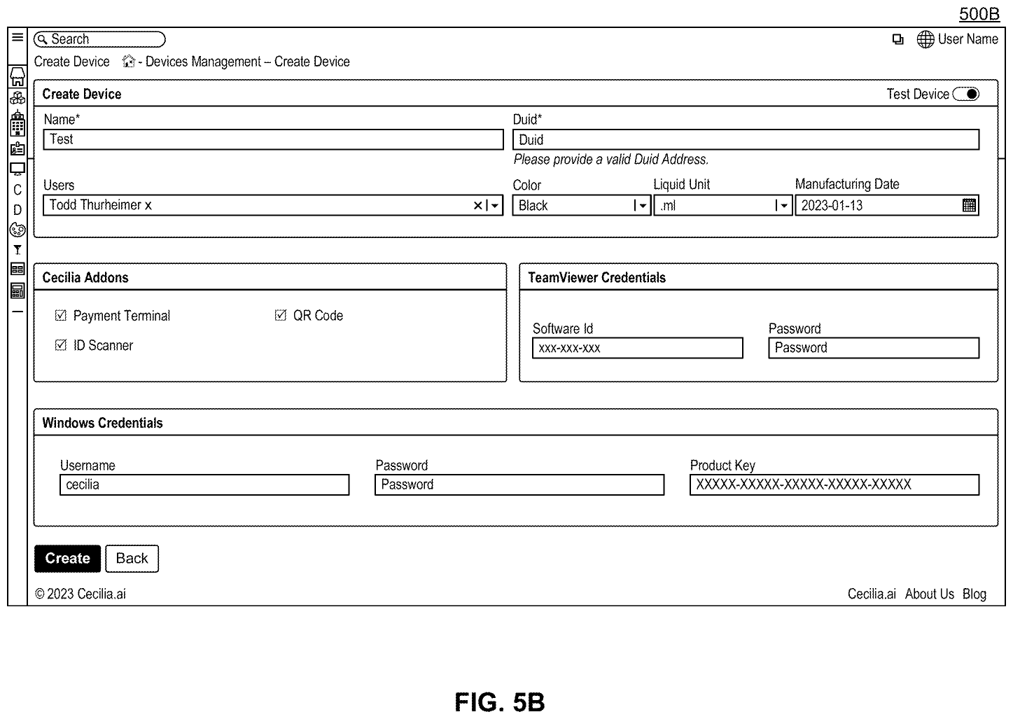

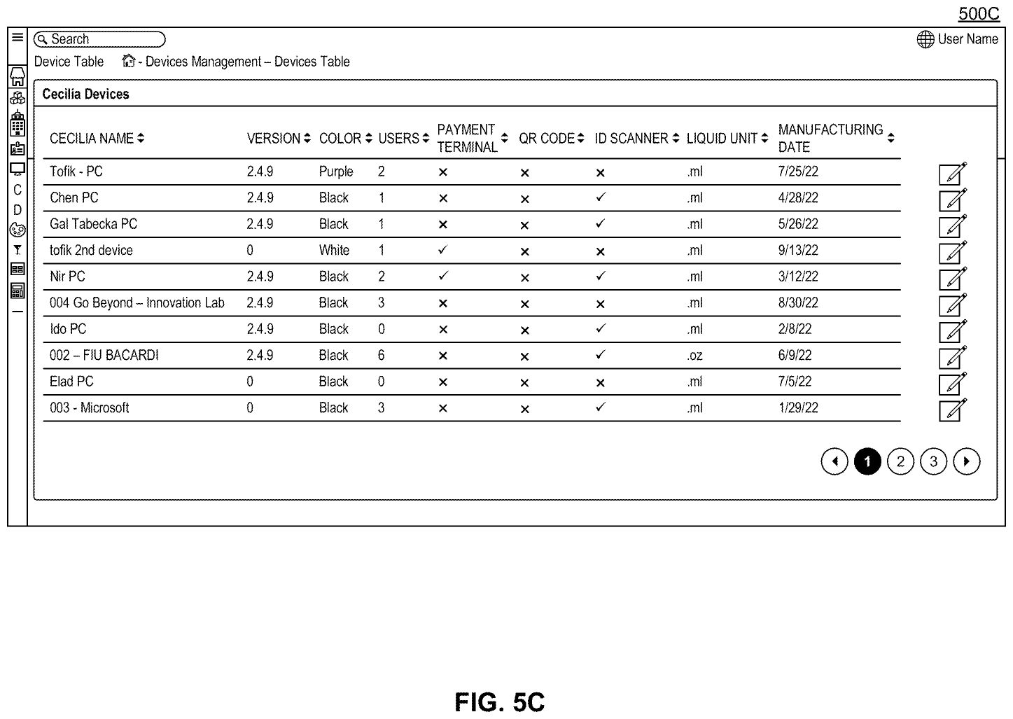

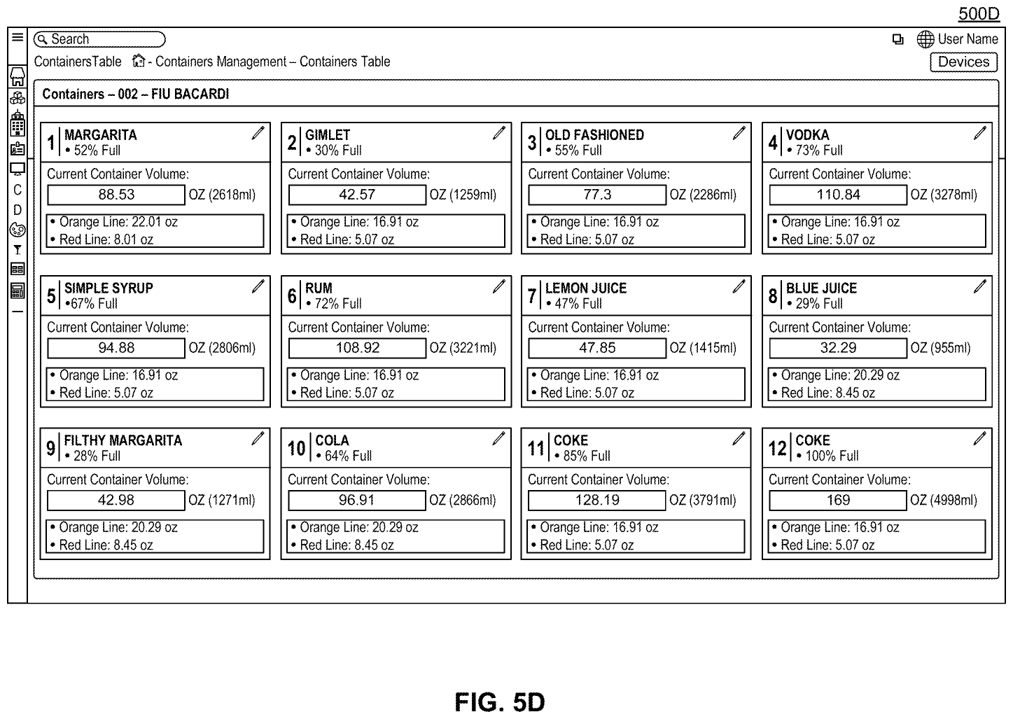

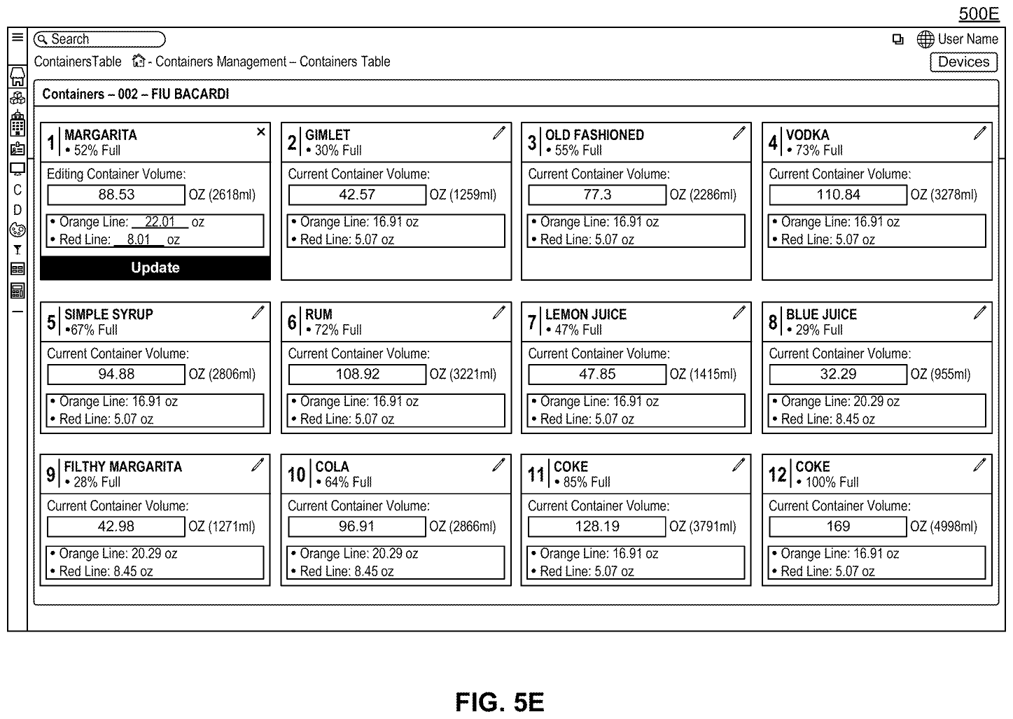

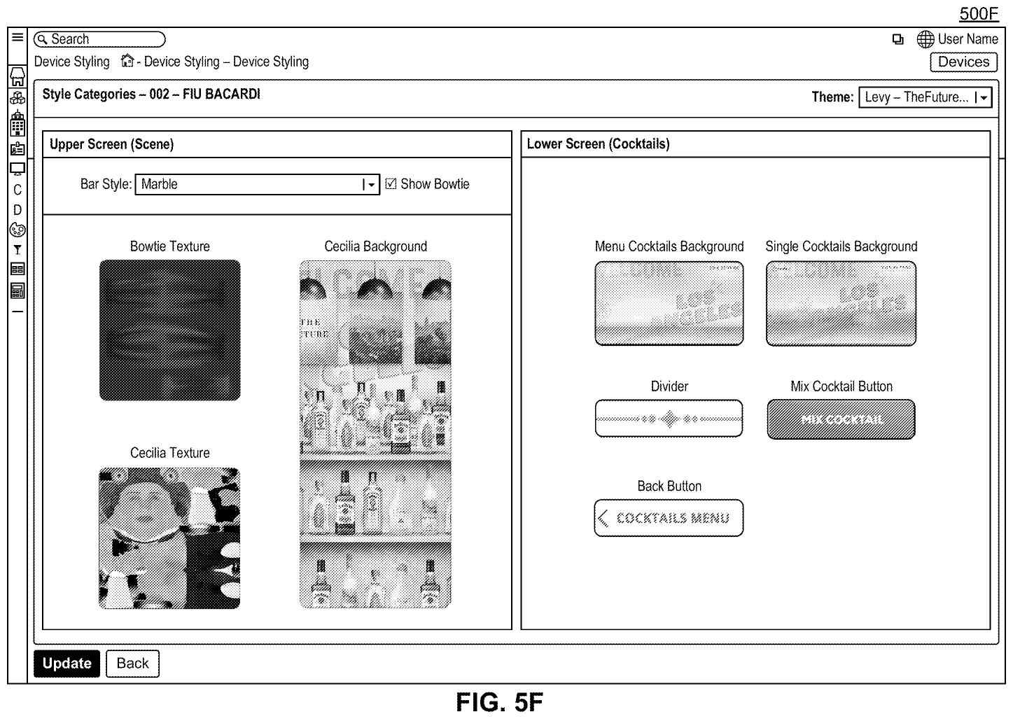

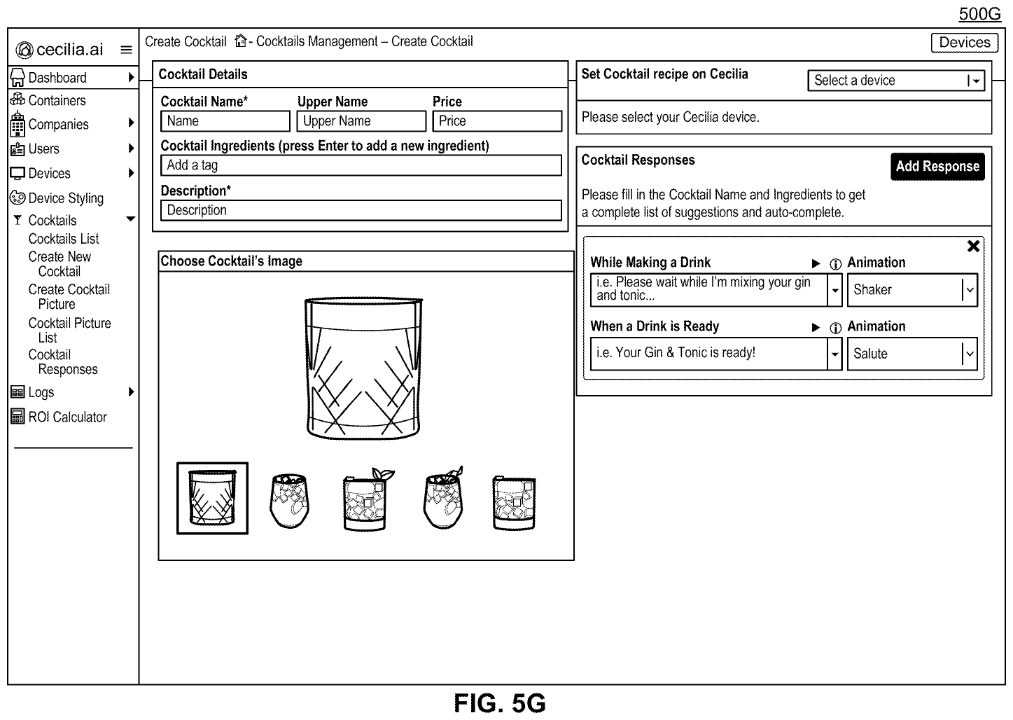

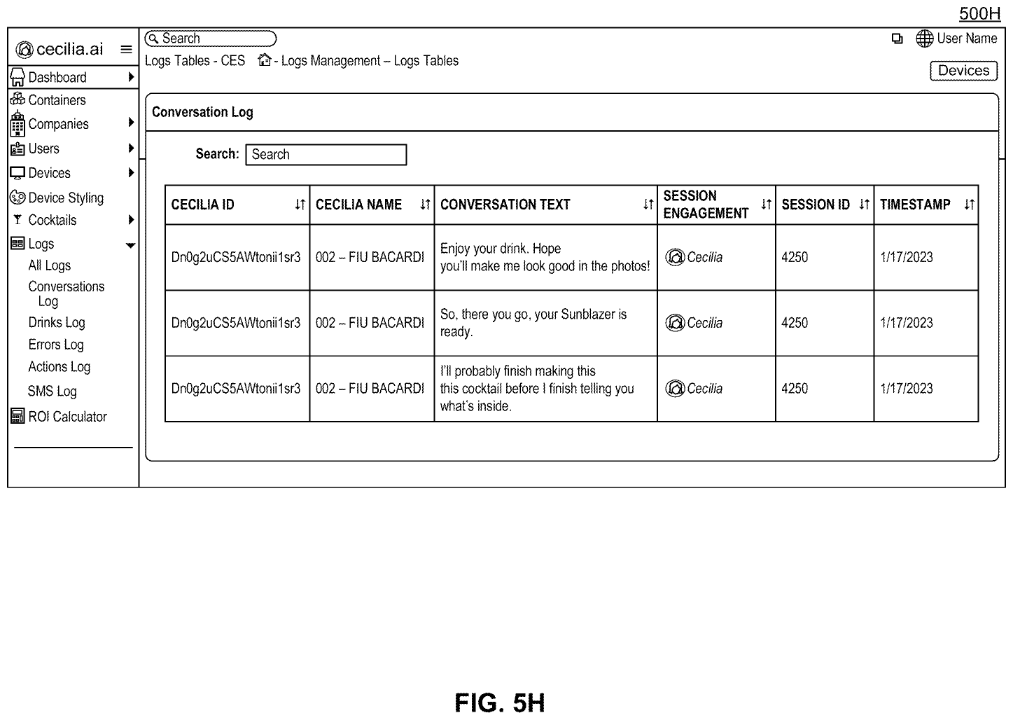

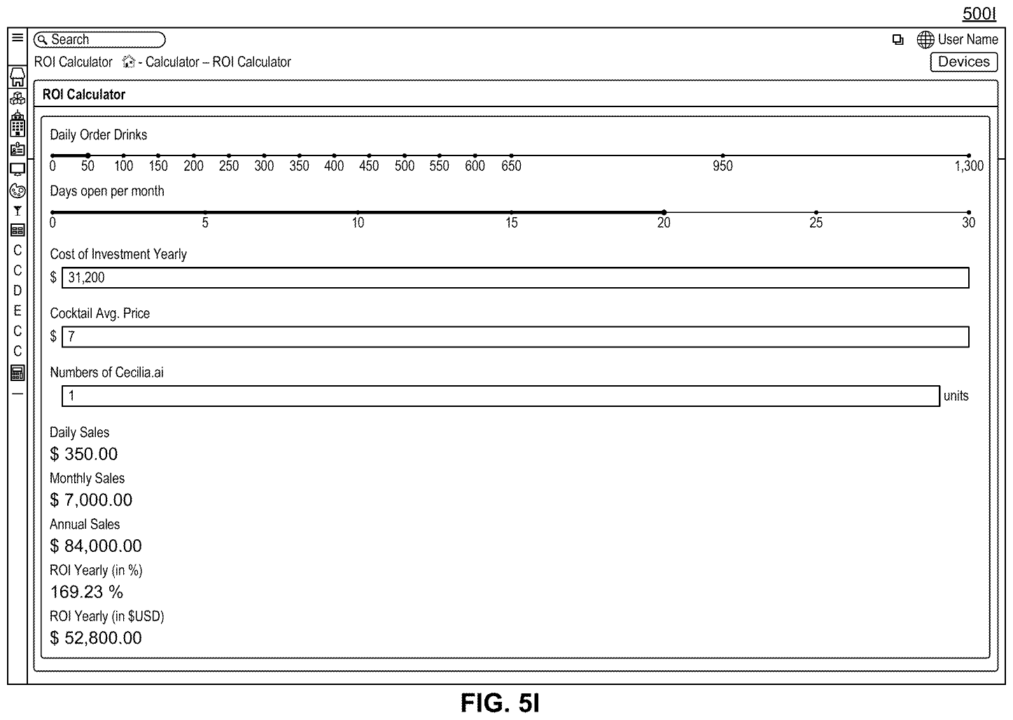

Customer-specific API 306D may be one or more specific APIs accessible for particular businesses. For example, hotels may access technical systems that that supply additional information about the hotel, book rooms, extend reservations, call a taxi, provide a restaurant recommendation, and perform other appropriate concierge services. An interactive bartender in a sports stadium may access an API that provides score updates and statistics, orders food at a concession stand, etc. Front end 303 may access customer-specific API 306D in response to a question from the customer received by interactive bartender 204. Moreover, this information may be configurable in the web portal discussed below in FIGS. 5A-5I. For example, the configured keywords list may be configured to include an API request/parameters/endpoint in association with the text response to allow interactive bartender 204 to dynamically retrieve information for inclusion in the text response or even to perform specific functionality offered by customer-specific API 306D in response to the customer's request. Access to customer-specific API 306D may be controlled with a login/password or other security credentials that are embedded within requests sent to customer-specific API 306D. These credentials by an administrator and associated with the configured API calls.

Microcontroller 308 may be used by interactive bartender 204 to dispense a selected beverage in the pre-configured proportions into a receptacle. The ingredients may be stored in a plurality of containers that connect to bay 110 using tubing, plumbing, or other suitable techniques for providing a liquid. Microcontroller 308 is described in further detail below with reference to FIG. 4.

Pumps 309 may be engaged by microcontroller 308 to pump stored ingredients in pre-configured quantities into a receptacle. Microcontroller 308 may control pumps 309 in response to a command from software (i.e., front end 303). Pumps 309 may each be connected to a tube. In one embodiment, there may be 12 such pumps, each corresponding to a particular ingredient in the plurality of containers.

Database 310 may store information relevant to the configuration and operation of interactive bartender kiosk 100. In one embodiment, database 310 may be a NoSQL database or other horizontally scaling database. However, in other embodiments, database 310 may be a relational database, a digital ledger technology or blockchain, or any other suitable database management system capable of storing and retrieving data. In an embodiment, database 310 may store data in persistent memory, a centralized storage area network (SAN), network-attached storage (NAS), redundant array of independent disks, and/or any other configuration of storage devices to supply sufficient storage capacity to store database tables and supporting structures. Sufficient storage may alternatively exist in any other physically attached magnetic storage, cloud storage, or additional storage medium.

Dashboard 312 may allow an administrator to configure and manage one or more interactive bartenders. In one approach, dashboard 312 may be a web application running on an application server, web server, or other mechanism for responding to network-based traffic. Dashboard 312 may run on premise, for instance, in a hosted environment, or on the cloud. In accordance with convention, the implementation of dashboard 312 may be logically divided into a presentation layer (e.g., ASP, JSP, BSP, etc.), business-logic layer (e.g., J2EE runtime environment, java beans, etc.), integration layer (connecting to other application servers or APIs), connectivity layer (e.g., HTTP, HTTPS, SSL, etc.), persistence layer (e.g., SQL, etc.), and other suitable layers. Dashboard 312 may authenticate incoming web traffic, interact with backend systems to formulate appropriate responses, and return these responses to an administrator. In one embodiment, dashboard 312 and front end 303 may be coupled, integrated, or running on the same machine.

Dashboard 312 may provide a suitable GUI that allows an administrator to configure interactive bartenders, such as displayed below with references to FIGS. 5A-5I. Dashboard 312 may employ user accounts to associate particular users with particular businesses. In this regard, dashboard 312 may also control access to the configuration on a user account or user type basis. Thus, certain users may have access only to the interactive bartender kiosks that are associated with their organizations. Some accounts may be view only. Control to the accounts may require a login and password.

Dispensed beverage 314 may be a beverage provided to customer 302 based on a selected beverage provided to interactive bartender 204.

FIG. 4 illustrates microcontroller 400 used in an interactive bartender kiosk to dispense beverages, according to some embodiments. As illustrated in FIG. 4, microcontroller 400 may include pins 402. Pins 402 may be used to connect wires to microcontroller 400 and construct a circuit. Pins 402 may be divided into different types of pins, e.g., for grounding, providing power, reading analog/digital signals, and other functions.

As mentioned above, microcontroller 400 may be connected, through pins 402, to pumps 309 used to transport liquid ingredients from holding containers within kiosk 100 into a glass in bay 110. In an example where kiosk 100 supports 12 ingredients, microcontroller 400 may be coupled to 12 pumps, with each pump able to move liquid through a tube from a holding container to a customer's glass.

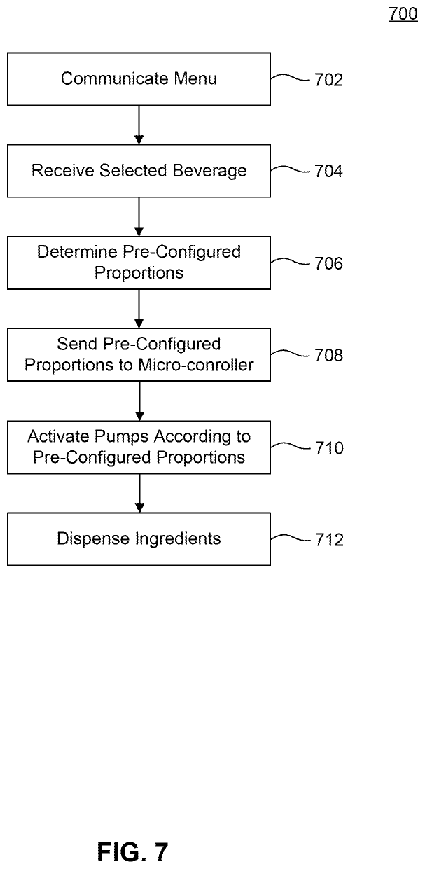

Microcontroller 400 may have specialized control software to synchronize pumps 309 so that the ingredients are mixed as they come out. For example, if a recipe calls for one ounce vodka and three ounces orange juice, microcontroller 400 may time activate or otherwise control throttling of pumps 309 so that the 1 ounce vodka is distributed throughout the 3 ounces of orange juice. This is described in greater detail below with respect to FIG. 7.

In addition, microcontroller 400 may have specialized control software to initialize pumps 309 and tubes. For example, on startup or on refilling ingredients, microcontroller 400 may prime a pump to make sure excess air in the tube is evacuated. In this way, liquid dispensed from the respective pumps can be measured precisely.

FIGS. 5A-5I are example screen displays of a web portal for configuring interactive bartenders, according to some embodiments. The screen display provided in FIG. 5A-5I are merely exemplary, and one skilled in the relevant art(s) will appreciate that many approaches may be taken to provide a suitable GUI in accordance with this disclosure.

FIG. 5A is example screen display 500A of a dashboard in a web portal for configuring an interactive bartender, according to some embodiments. Screen display 500A may be a landing page for an administrator visiting the web portal. In some embodiments, screen display 500A may aggregate and summarize data across more than one interactive bartender deployed by an organization. The administrator may select a device button that allows administrator to configure/view a particular interactive bartender kiosk 100, as the configurations of the interactive bartenders may differ. For example, a hotel chain could configure each deployed interactive bartender kiosk at hotel properties via the same dashboard. The hotel chain may view the dashboard in the aggregate (across all machines) or select a particular interactive bartender kiosk to view the reporting data for that particular interactive bartender kiosk.

The dashboard exemplified in screen display 500A displays a variety of information about the performance of an interactive bartender kiosk. In screen display 500A, this includes the total number of sessions, the total number of drinks served, a conversion percentage (total drinks/total sessions * 100), the average length of conversations conducted by the interactive bartender, and a variety of suitable graphs and figures that reflect the behavior of the interactive bartender. Screen display 500A may also include a real-time view of the conversations transpiring at the interactive bartender. One skilled in the arts will understand that screen display 500A may include a variety of additional data, reports, and graphs related to the performance of the interactive bartenders.

FIG. 5B is example screen display 500B of a create-device page in a web portal for configuring an interactive bartender, according to some embodiments. The create-device page that allows an administrator to add a new device to the fleet of configurable interactive bartenders. Selectable options including “payment terminal,” “ID Scanner,” and “QR Code” may be selected to indicate the features that are available in the new device. This new device may correspond to an installed interactive bartender kiosk in a particular location. Screen display 500B includes various fields for effectuating remote control and configuration of the interactive bartender kiosk including user credentials.

FIG. 5C is example screen display 500C of a devices page in a web portal for configuring an interactive bartender, according to some embodiments. Screen display 500C may list the devices that are accessible for a particular business and provide relevant summary information about each deployed kiosk. This includes the options selected for that configured device (“payment terminal,” “ID Scanner,” and “QR Code”) and the liquid unit (between milliliters and ounces) that the interactive bartender kiosk uses as part of its operation.

FIG. 5D is example screen display 500D of a containers page in a web portal for configuring an interactive bartender, according to some embodiments. Screen display 500D may provide an administrator the ability to configure the particular ingredients used within an interactive bartender kiosk. These ingredients will then be referenced to assemble a menu of beverages as discussed below. In the exemplary embodiment of FIG. 5D, the interactive bartender kiosk has 12 separate containers that can hold ingredients. These ingredients include margarita mix, gimlet mix, old fashioned mix, vodka, simple syrup, rum, lemon juice, blue juice, filthy margarita mix, cola, and coke. But this is not limiting and any number of suitable ingredients may be configured via screen display 500D.

As indicated in screen display 500D, interactive bartender kiosk 100 also tracks the current volume of each of the configured ingredients in real-time. This value is displayed in screen display 500D for each of the containers. The availability of this information allows interactive bartender kiosk 100 to generate notifications and disable drinks that include a dwindling ingredient as it nears depletion.

FIG. 5E is example screen display 500E of a containers page in a web portal for configuring an interactive bartender, according to some embodiments. Screen display 500E illustrates the editable and configurable nature of the containers page. An administrator may update the name of the container and also configure an “Orange Line” and a “Red Line.” These values may be referred to below as a warning value and a stop value, respectively. The warning value may be a preferred volume—when the tracked volume for that container drops below the warning value, a notification may be generated and sent to an appropriate staff member informing the staff member that they need to refill that ingredient. The stop value may be a second preferred volume—when the tracked volume for that container drops below the stop value, a notification may be generated and sent to an appropriate staff member and, moreover, menu items that use the ingredient may also be immediately disabled. This prevents customers from ordering a drink that interactive bartender kiosk is incapable of producing.

FIG. 5F is example screen display 500F of a device-styling page in a web portal for configuring an interactive bartender, according to some embodiments. The device-styling page may allow the administrator to configure the texture of interactive bartender 204, background 202, and other graphical elements of the interactive bartender experience. For example, a user may upload appropriately formatted images or select from templates provided in the web application to uniquely tailor the look and feel of interactive bartender 204 for their location.

FIG. 5G is example screen display 500G of a create-cocktails page in a web portal for configuring an interactive bartender, according to some embodiments. In the create-cocktails page, an administrator may create a beverage to add to the menu of beverages provided by the interactive bartender. This includes a description of the beverage, the ingredients, an associated image, text responses to provide to the customer when preparing the beverage, and animations to perform while mixing the beverage. An administrator may further configure information needed to access customer-specific API 306D to access additional information and perform customer-specific functions. For example, the text response may be configured with appropriate an API endpoint, associated parameters, and credentials to dynamically retrieve information for inclusion in the text response or even to perform specific functionality. The returns from the API may further be included in the response using techniques known to those skilled in the relevant art. An administrator may also specify mixing details for the cocktail by specifying intervals/quantities that allow for the staggering of the beverage to achieve mixing.

FIG. 5H is example screen display 500H of a logs page in a web portal, according to some embodiments. The logs page may display the logs of past conversations. The page may include the ability to sort and group, generate reports, and glean further information from the stored logs of conversations. The logs page may be important in refining the configured keywords list to address conversations that did not result in an appropriate response. For example, an administrator may view the conversation text and determine an additional configurable record to add to the keywords to address future conversations in the same vein.

FIG. 5I is example screen display 5001 of a return-on-investment page in a web portal for configuring an interactive bartender, according to some embodiments. The return-on-investment page may provide financial information related to interactive bartender kiosk 100. Access to the return-on-investment page may be limited to particular users or user types.

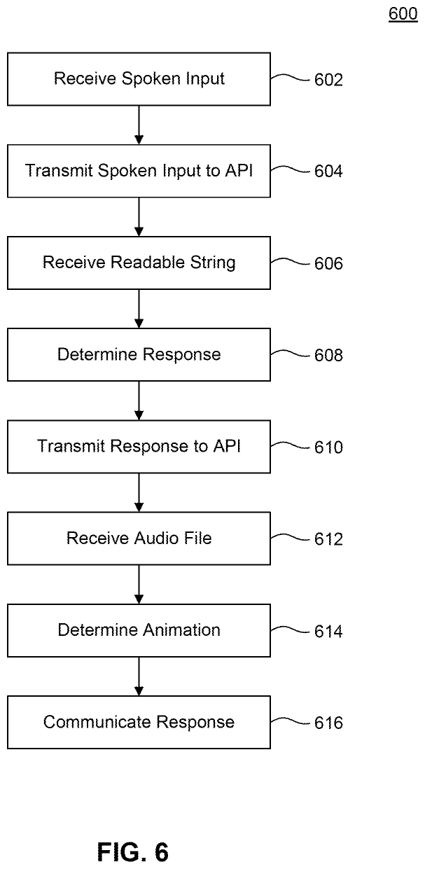

FIG. 6 illustrates method 600 for processing spoken input received from a customer and communicating a response to the customer using an interactive bartender, according to some embodiments. Method 600 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art(s).

In 602, interactive bartender kiosk 100 may deploy interactive bartender 204 to interact with and receive spoken input or voice command from customer 302. In one embodiment, interactive bartender 204 may receive the spoken input from customer 302 via microphone 108 and convert the spoken input into an audio file or other electric signal for use in subsequent steps. For example, customer 302 may state to interactive bartender any number of statements/questions/exclamations that a human might utter, e.g., “What time is the hockey game tonight?”, “How's it going, Cecilia?”, “What's the meaning of life?”, or “I would like to see a menu of drinks.” Interactive bartender kiosk 100 may capture an audio file of the statement via microphone 108. Interactive bartender kiosk 100 may display microphone icon 206 to customer 302 to indicate that interactive bartender 204 can receive spoken input. In another embodiment, spoken input may be enhanced, augmented, or replaced by written input, e.g., using a touchscreen or entered via a keyboard, and in such an embodiment, certain steps in method 600 may not be necessary and may be skipped.

In 604, interactive bartender kiosk 100 may transmit a representation (i.e., an electric signal) of the spoken input provided by customer 302 to an appropriate cloud-based artificial intelligence API in external APIs 306, such as cognitive services API 306A. Such an API may be a REST API accessible through HTTP or other suitable protocols. Interactive bartender 204 may access the API using an appropriate endpoint or function and include the representation of the spoken input as a parameter. Credentials for accessing cognitive services API 306A may be stored in database 310, retrieved by front end 303, and transmitted to cognitive services API 306A to authenticate the transmission.

In 606, interactive bartender kiosk 100 may receive a readable string from cognitive services API 306A that represents the spoken input in text. Front end 303 may receive in return to the request sent in 604 the text string representation of the statement of customer 302−e.g., a literal string of “What time is the hockey game tonight?”, “How's it going, Cecilia?”, “What's the meaning of life?”, or “I would like to see a menu of drinks.”

In 608, interactive bartender kiosk 100 may use the readable string received in 606 to determine an appropriate response to the spoken input to provide back to customer 302. To achieve a conversational experience that is fully customizable, front end 303 may retrieve a configurable keywords list either from local storage, the cloud, database 310, or other suitable location. In one implementation, the keywords list may include a number of records, with each record including a match string, a text response, and a priority. Front end 303 may perform pattern matching to determine a subset of entries in the keywords list with match strings that match the readable string. For example, a short exemplary keywords list may include the following records:

| Keywords List | Response | Priority |
|---|---|---|
| meaning of life | 42, percent of alcohol | 2 |
| stupid, ugly, moron, | Hey that's rude! No drink for you! | 2 |
| dumb, loser | | |
| computer, robot, virtual, | You revealed my secret. I'm not human. | 1 |
| bot, chatbot, machine | Please don't tell anyone, okay? | |
| thinking about, thinking | Nothing. I was just wondering what drink | 2 |
| of, on your mind | would match your shirt. | |
| tip, service, gratuity | No, I am doing this voluntarily. | 2 |
| favorite hobby | I like dancing, of course | 2 |
| menu | Sure, let me show you the menu of drinks that | 1 |
| | I have available. | |

The above table is just exemplary and an actual keywords list will likely include a large number records to cover the fully array of possible language provided by customer 302. But for example, if customer 302 asks “What is the meaning of life,” interactive bartender kiosk 100 may find a matching record of “meaning of life” in the keywords list and then retrieve the associated text response “42, percent of alcohol.” If the customer says, “Hey Cecilia, you're just a dumb chatbot”, kiosk 100 may find two matches in the keywords list (records 2 and 3 above), break the tie with the priority field, and determine a response of “You revealed my secret. I'm not human. Please don't tell anyone, okay?” The keywords list may be configurable by an administrator in dashboard 312 so that the actual behavior of interactive bartender 204 may be different in different locations. In some embodiments, the keywords list may be categorized to ease administration—e.g., suitable categories may exist for “Small Talk,” “Brand/Event Related,” “Informative,” “For Fun,” “Menu Related,” etc. and the categories themselves may be configured by an administrator in the web portal.

Front end 303 may also determine whether any additional API calls are needed based on the text response, e.g., calls to customer-specific API 306D. Front end 303 may format and transmit any such configured calls as appropriate, receive a response from the accessed APIs, and adjust/update/de-parameterize the text response as appropriate.

In 610, interactive bartender kiosk 100 and/or front end 303 may then transmit the text response determined in 608 to cognitive services API 306A. Front end 303 may access the API using an appropriate endpoint or function that differs from the function used in 604. Interactive bartender 204 may include the text response determined in 608 as a parameter, for example, front end 303 may include a text string of “42, percent of alcohol” as a parameter to a certain function extended by the API. In 612, in response to the API request in 610, front end 303 may receive an audio file from cognitive services API 306A. The audio file may be a spoken representation of the transmitted text response.

In 614, front end 303 may determine an appropriate animation for the interactive bartender. In one approach, the appropriate animation may be associated with the text response in the keywords list and configured in dashboard 312. For example, if the question was “What is the meaning of life,” and the text response was “42, percent of alcohol,” a configured animation may be a shrug of the shoulders, the pointing of a finger, a laughing animation, etc.

In 616, interactive bartender kiosk 100 may communicate the audio file to customer 302. Interactive bartender kiosk 100 may play the audio file received in 614 via speakers 106. Interactive bartender kiosk 100 may simultaneously cause interactive bartender 204 to perform the animation retrieved in 614. Interactive bartender kiosk 100 may simultaneously display a text version of the appropriate response on screen 104, i.e. as response text 208.

FIG. 7 illustrates a method for dispensing a selected beverage to a customer, according to some embodiments. Method 700 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art(s).

In 702, as part of conversational interactions between interactive bartender 204 and customer 302 that transpire as discussed above with reference to FIG. 6, interactive bartender 204 may communicate a menu of beverages to customer 302. Interactive bartender kiosk 100 may display a menu of beverages on screen 104, such as described above as beverages 210. In one use case, customer 302 may ask interactive bartender 204, “Can you please display a menu?” or “What do you have to drink?” or other request to see the menu of beverages. Or interactive bartender 204 may suggest to customer 302 at any point during a conversation, “Would you like to see a menu of beverages?” Interactive bartender 204 may also provide the menu to customer 302 as a drink recommendation, i.e., selecting a particular drink based on data provided by customer 302.

In 704, interactive bartender 204 may receive a selected beverage from customer 302. For example, customer 302 may orally state in conversation to interactive bartender 204, “I would like a gin and tonic.” Interactive bartender 204 may recognize that customer 302 is requesting this particular drink. In another embodiment, customer 302 may use a touchscreen or other input device associated with screen 104 to select a particular drink from the menu of beverages. For example, customer 302 may select mix cocktail button 228 from a details page such as that displayed in screen display 200C to select a beverage for preparation.

In 706, interactive bartender kiosk 100 may determine the pre-configured portions for the ingredients in the selected beverage. Each beverage in the menu of beverages may be configured by an administrator to include particular ingredients in particular proportions. For example, a gin and tonic may be configured to have 2 ounces of gin and 4 ounces of tonic. Interactive bartender kiosk 100 may also determine mixing protocols (described below) for each ingredient in the selected beverage.

In 708, interactive bartender kiosk 100 and/or front end 303 may communicate the pre-configured portions and associated information determined in 706 to microcontroller 400. In an embodiment, microcontroller 400 may be programmed to mix certain beverages by staggering the pouring of the ingredients. For example, a simple gin and tonic consisting of 1 part gin and 1 part tonic may be mixed by dividing the parts into smaller parts and staggering the pouring. That is, microcontroller 400 may pour a portion of gin, then a portion of tonic, then a portion of gin, then a portion of tonic, etc.

In another example, the gin and tonic may pour simultaneously. However, staggering may be necessary for cocktails where the quantity of each ingredient is unequal. For example, a vodka-orange juice recipe may have 1 part vodka and 2 parts orange juice. If the vodka and orange juice were dispensed simultaneously at the same speed, the vodka would finish dispensing before the orange juice and the cocktail would be uneven, with too much liquor at the bottom and too much mixer at the top.

In 710, microcontroller 400 may activate pumps 309 according to the pre-configured portions and mixing information. In the above-described vodka-orange-juice recipe, microcontroller 400 may dispense the vodka at intervals along with the orange juice. For example, suppose the recipe called for 50 mL of vodka and 100 mL of orange juice. Microcontroller 400 may activate the orange juice pump to dispense 100 mL. While activating the orange juice pump, microcontroller 400 may activate and deactivate the vodka pump five times to dispense 10 mL at a time. Microcontroller 400 may activate and deactivate at substantially even intervals to distribute the five activations substantially evenly over the course of the entire period of time the orange juice pump is activated to distribute the 100 mL of orange juice. In this way, the resulting cocktail is substantially evenly mixed.

Alternatively or additionally, instead of staggering the timing of the pump activation, microcontroller 400 may throttle the pump speed. In the vodka-orange juice example above, microcontroller 400 may determine that, because the recipe calls for 50% less vodka than orange juice, the vodka pump should be activated at 50% speed of the orange juice pump. In this way, the vodka and orange juice are dispensed evenly in the glass resulting in a cocktail that is substantially evenly mixed. In one embodiment, these mixing behaviors may be individually configured for each beverage in the menu of beverages and each ingredient in the plurality of containers.

In 712, interactive bartender kiosk 100 may dispense the selected beverage in the pre-configured proportions into a receptacle for enjoyment by customer 302.

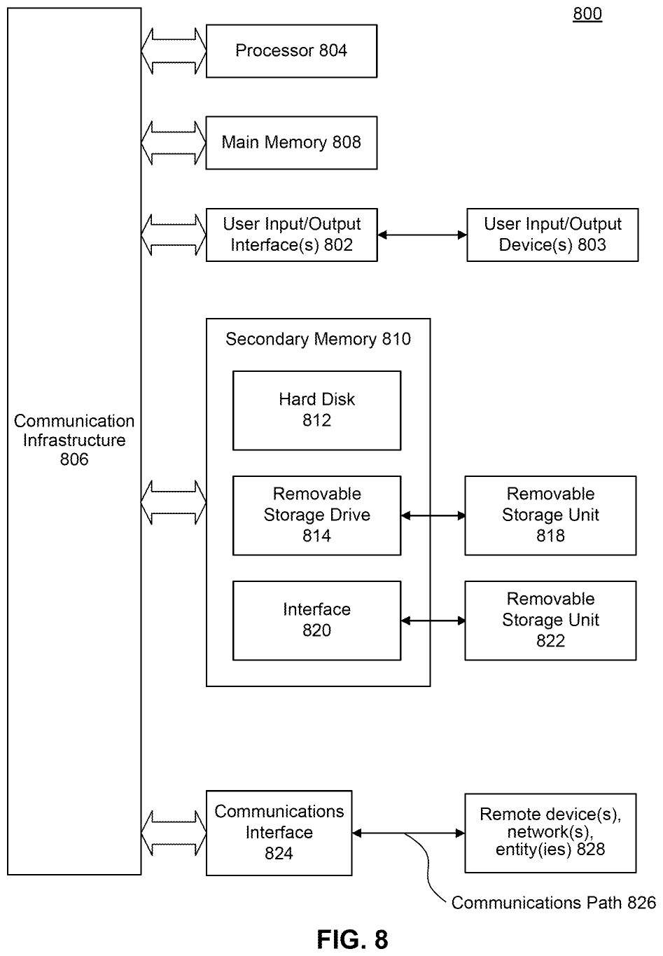

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 808, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system for providing an interactive bartending experience, comprising:
a plurality of containers storing a plurality of ingredients;
a microcontroller;
a database;
a processor configured to:
display an interactive bartender;
in response to receiving a voice input from a user, perform speech recognition on the voice input, determine a response to the voice input, and cause the interactive bartender to provide the response to the user;
communicate a menu of drinks to the user, a drink in the menu of drinks comprising at least one ingredient from the plurality of ingredients;
in response to receiving a selected drink from the menu of drinks, determine pre-configured proportions for the at least one ingredient in the selected drink; and
engage the microcontroller to dispense the at least one ingredient from the plurality of containers in the pre-configured proportions into a receptacle.

2. The system of claim 1, wherein to determine the response to the voice input, the processor is further configured to:
transmit an audio file recording of the voice input to a cognitive services application programming interface (API);
receive a readable string of the voice input from the cognitive services API; and
reference a configured keyword list using the readable string to determine the response.

3. The system of claim 2, the processor further configured to:
compare the readable string to match strings in the keyword list to determine a subset of records in the configured keyword list having a matching readable string; and
select as the response a text response for a record in the subset of records with a highest priority.

4. The system of claim 1, wherein to provide the response to the user, the processor is further configured to:
transmit the response to the voice recognition API; and
in response to receiving an audio file from the voice recognition API, cause the interactive bartender to play the audio file for the user.

5. The system of claim 1, the processor further configured to:
determine an animation associated with the response; and
display the animation while providing the response to the user.

6. The system of claim 1, the processor further configured to:
retrieve a warning value that indicates a quantity of an ingredient in the plurality of ingredients;
determine that an amount of the ingredient is less than the warning value; and
generate and send a notification to an administrator.

7. The system of claim 1, the processor further configured to:
retrieve a stop value that indicates a quantity of an ingredient in the plurality of ingredients;
determine that an amount of the ingredient is less than the stop value;
generate and send a notification to an administrator;
determine one or more menu items in the menu of drinks that use the ingredient; and
remove the one or more menu items from the menu of drinks.

8. The system of claim 1, wherein to dispense the at least one ingredient the processor is further configured to:
mix the selected drink by sending at least one signal to dispense a first portion of a first ingredient, then dispense a first portion of a second ingredient, then dispense a second portion of the first ingredient, and then dispense a second portion of the second ingredient.

9. The system of claim 1, wherein to display the interactive bartender the processor is further configured to:
determine a background and a texture; and
apply the background and the texture to a look and feel of the interactive bartender.

10. The system of claim 1, wherein to communicate the menu of drinks the processor is further configured to:
retrieve an image associated with each drink in the menu of drinks; and
display the image in association with the drink.

11. The system of claim 1, the processor further configured to:
prompt the user to scan an identification document;
verify the scan of the identification document using a third-party application programming interface (API);
receive from the third-party API a hash variable; and
associate the hash variable with the user.

12. The system of claim 1, the processor further configured to:
connect to a third-party application programming interface offered to receive a payment for the selected drink.

13. The system of claim 1, wherein the interactive bartender is a three-dimensional avatar.

14. A method for providing an interactive bartending experience, comprising:
displaying, by one or more processors, an interactive bartender that converses with a user and communicates a menu of drinks to the user, a drink in the menu of drinks comprising at least one ingredient from a plurality of ingredients;
in response to receiving a voice command from the user that indicates a selected drink from the menu of drinks, determining pre-configured proportions for the at least one ingredient in the selected drink; and
engaging a microcontroller to dispense the at least one ingredient from a plurality of containers in the pre-configured proportions into a receptacle.

15. A system comprising:
a memory;
a processor coupled to the memory and configured to:
provide a web portal that allows an administrator to specify an interactive bartender configuration, the interactive bartender configuration comprising a menu of drinks, wherein a drink in the menu of drinks comprises at least one ingredient from a plurality of ingredients and pre-configured proportions for the at least one ingredient; and
transmitting the interactive bartender configuration to an interactive bartender kiosk, wherein the interactive bartender kiosk, in accordance with the interactive bartender configuration, displays an interactive bartender that converses with a user using natural language, provides the menu of drinks, recognizes a voice input provided by the user, determines a selected drink, and dispenses the at least one ingredient from a plurality of containers in the pre-configured proportions into a receptacle.

16. The system of claim 15, wherein the interactive bartender configuration further comprises a configured keyword list, a record in the configured keyword list comprising a match string, a text response, and priority, wherein the interactive bartender kiosk determines an appropriate response to the voice input received from the user using the configured keyword list.

17. The system of claim 15, the processor further configured to:
receive a second interactive bartender configuration from the administrator; and
associate the second interactive bartender configuration with a second interactive bartender kiosk.

18. The system of claim 15, wherein the interactive bartender configuration further comprises a warning value for each ingredient in the plurality of ingredients, wherein the warning value indicates a quantity of an ingredient in the plurality of ingredients, and wherein the interactive bartender kiosk generates and sends a notification to the administrator when an amount of the ingredient is less than the warning value.

19. The system of claim 15, wherein the interactive bartender configuration further comprises a stop value for each ingredient in the plurality of ingredients, wherein the stop value indicates a quantity of an ingredient in the plurality of ingredients, and wherein the interactive bartender kiosk generates and sends a notification to the administrator when an amount of the ingredient is less than the stop value, determines one or more menu items on the menu of drinks that use the ingredient, and removes the one or more menu items from the menu of drinks.

20. The system of claim 15, the processor further configured to:
receive log data from the interactive bartender kiosk, the log data comprising a number of drinks served, a time of service for the number of drinks, and one or more records of conversations with the user; and
display a dashboard that summarizes the log data.
